(19) United States
(12) Patent Application Publication
(10) Pub. No.: US 2006/0252880 A1
(43) Pub. Date: Nov. 9, 2006

(54) Method for producing paints, especially by mixing predetermined amounts of liquid products

(76) Inventor: Nickolas Bizzio, Monte-Carlo (MC)

Correspondence Address: FLYNN THIEL BOUTELL & TANIS, P.C., 2026 RAMBLING ROAD, KALAMAZOO, MI, 49008-1631, US

(21) Appl. No.: 11/482,312

(22) Filed: Jul. 7, 2006

Related U.S. Application Data
(63) Continuation of application No. 10/475,227, filed on May 27, 2004, now abandoned.

(51) Int. Cl. C08G 61/10

(52) U.S. Cl. 524/783

(57) ABSTRACT

A method for producing paints, especially by mixing predetermined amounts of coloring products with basic varnish products, involves the following steps: (a) preparation of a liquid monobasic component containing predetermined amounts of a binding element and a filler element, the proportion of said amounts depending upon the final desired quality of paint; and (b) addition of predetermined amounts of at least one liquid component selected from the group including a liquid component comprising TiO₂ titanium white and a liquid component containing a filler to a liquid monobasic product, in keeping with proportional formulations which are optimized according to the final coloration of the paint thus desired. In order to obtain final paint colorations which are different from white, predetermined amounts of liquid components containing coloring pigments are added to the liquid monobasic component.

This is a continuation of Ser. No. 10/475,227, filed May 27, 2004, which was the national stage of International Application No. PCT/EP01/04509, filed Apr. 20, 2001, which International Application was not published in English.

This invention refers to a method for producing paints, especially by mixing predetermined amounts of liquid products. It also relates to a tintometric system and a liquid basic product for making paints.

The methods for producing colored paints have for some time been based on so-called tintometric systems. The underlying idea of said systems is to color a basic product with good covering characteristics guaranteed, for example by the presence of a predetermined percentage of colored pigments which, by mixing with each other and with the basic product, give the finished paint the desired color. The percentages of coloring products necessary to obtain a specific color are established by proportional formulae worked out by the producers of basic products and colorings.

However, the use, alone, of basic products containing TiO₂ does not allow all the colors in the whole color range to be achieved. Although the covering power of a black pigment is very strong, for example, it will never be possible to obtain a completely black paint if the basic product contains small percentages, even very weak ones, of TiO₂ which, as is well known, is white in color: this white color would inevitably contaminate the black and would therefore give a paint which was more or less grey in color. Therefore, to obtain the color black, as well as many other very dark colors, tintometric systems have been suggested. Besides the group of basic products containing predetermined percentages of Ti0₂, these include a transparent basic product—that is, without Ti0₂-containing mainly a thickening neutral-colored or only slightly covering product called a “filler” (mastic), which is used to give body to the finished paint so that it acquires the desired consistency.

For the above-mentioned reasons, even the known and the most “improvised” tintometric system must necessarily provide for the selection and use, according to the desired color of the finished paint, of a basic product chosen from a group including two distinct basic products: a white basic product, containing high percentages of TiO₂, typically about 20%, and a neutral one, without TiO₂. The selection of one or the other type of basic product is normally made by specialized personnel, referring to instructions supplied by the producers of the coloring products in relation to the specific color desired for the final paint.

Of course, in this tintometric system, which is limited to two single basic products, the optimum yield is generally obtained only for colors that are at the two ends of the color range, that is, for very dark colors (in order to obtain these, neutral basic products must be used) or for pastel colors (produced from white basic products with a high TiO₂ content). Certain producers of colorings have proposed tintometric systems that use more than two basic products to try to obtain optimum results equally in the intermediate field of colors between dark colors and pastel colors, while other producers have even proposed colored basic products, as well as white bases with a different TiO₂ strength, and the neutral or transparent one. In some cases, the point has even been reached whereby tintometric systems have been proposed, which, according to the desired color of the finished paint, provide for the selection and use of a basic product chosen from a group that includes as many as ten different types.

We immediately notice that tintometric systems are in the process of evolving towards an ever greater number of basic products, seeking to optimize the use of colored pigments—which are certainly costly and often also polluting—in order to reduce the percentages of said pigments necessary for the production of all the colors in the color range, while at the same time guaranteeing satisfactory covering characteristics. This evolution, however, involves serious disadvantages in the production of finished paints since they require more and more specialized personnel to select the right basic product to obtain the desired color of paint. The use of different basic products also means increasing the stocks needed to guarantee the constant availability of the most suitable basic product to produce a specific paint. The industrial production-methods and the management, even commercial, of different basic products, naturally involve high costs and long time-spans.

Paradoxically, if we take to extreme lengths the trend that has recently manifested itself, that is, to supply an ever greater number of basic products, we would very soon find ourselves facing the same problems (large warehouse stocks and low product rotation) which, in the past, led to the adoption of the first tintometric systems.

The disadvantages outlined above are magnified by the fact that, normally, paints with different chemical and physical characteristics have to be produced according to their applications and for each type of paint it will be necessary to provide for a different group of basic products, as defined by the tintometric system adopted. If, therefore, one wants to have basic varnish products suitable for different uses—appropriate, for example, for inside or outside, for applying on different surfaces (wood, stone, brick, glass, paper, etc.), for professional or amateur use, or with special characteristics of transpiration, anti-mildew, high or low quality, etc.—it will therefore be necessary, with traditional tintometric systems, to have an enormous number of bases in stock, causing several problems as one might easily imagine, namely, of management, restocking and storage.

The aim of this invention is to solve the drawbacks of the known technique and in particular, to overcome completely the problems that arise with the evolution of tintometric systems and the latest trends, as briefly mentioned above. The aim of the invention is above all to supply a method of producing paints that can be carried out easily and, if possible, automated so that even an inexpert user can obtain a colored paint to his or her liking without having to worry about selecting the most suitable basic product each time, to obtain the final color he or she desires to give to the finished product.

Another aim of the invention is to produce a production system for paints that allows the use of colored pigments and the covering power of the finished paint to be optimized. In order to be able to achieve the above-mentioned aims, the invention has as its subject a method of the type indicated in the preface to this description, characterized in that it is composed of the following phases:

a) preparation of a liquid monobasic component comprising proportionately predetermined amounts of a binding element and a filler element;

b) addition of predetermined amounts of at least one liquid component selected from the group including:
a liquid component comprising Ti0₂ titanium white;
liquid component comprising a filler element, to the liquid monobasic component, when the final paint is prepared and in keeping with formula which are predetermined and optimized according to the color desired for said final paint.

To obtain a final paint in a color different from white, one or more liquid components comprising pigments or coloring elements are added to the liquid monobasic component.

In other words, the basic idea of the invention consists of the initial preparation of one single liquid product, a primary liquid component, which we will call by the name of “monobasic” hereafter in this description, ready to be used to formulate paints of any desired color, by adding, in a selective, optimum manner, titanium white, pigments and filler.

Finally, the invention allows the formulation of the basic product, in the traditional meaning of the term, according to the color to be obtained, which distinguishes it radically from the tintometric systems already in existence where the formula for the different basic products is strictly pre-established by the producer.

The advantages of the invention are immediately recognizable. First of all, the amounts of products in the warehouse are considerably reduced since it is generally only necessary to keep stocks of colorings, titanium white and filler, along with only one other basic product for each specific application which, in the rest of this description, will be correctly identified by the above term “monobasic” in order to distinguish it from the basic products of traditional tintometric systems.

Another important advantage derives from the fact that, according to the invention, it is possible to optimize the amount of colorings necessary to obtain each color shade in the color range, while at the same time optimizing the covering power of the finished paint. One should, in fact, take into account the fact that the greatest cost in a finished paint is represented by the colorings or pigments used to produce it and, in addition, that said colorings and pigments are normally polluting for the environment and must therefore be eliminated in an appropriate manner, which logically involves extra costs such as, for example, the receptacles to contain them. With the possibility of varying the TiO₂ titanium white content, according to each specific color shade, one can achieve the optimum minimum level of colorings needed to obtain this same color shade without it being necessary—as happens with the known technique—to add, for example, surplus amounts of colorings to correct or compensate an excess of TiO₂ in the traditional basic product

Another advantage of the invention lies in the possibility of almost completely automating the production process of finished paints. Since it is not necessary to have specialized personnel to select the type of basic product which is most suitable for producing a finished product in the desired color, it is possible to produce a dispensing machine which distributes, into a can or recipient pre-filled with monobasic product, predefined amounts of colorings, Ti0₂ and filler, plus any thinning agents and additives, in water or solvent, in order to obtain the desired color of paint.

Other characteristics and advantages will be seen in the detailed description that follows, relating to examples concerning productions which must not, however, be considered as limiting for the invention.

In general terms, a finished paint is composed of the following elements or groups of main elements that define its chemical-physical properties:

a) one or more film-forming or binding substances, to which the hardness and the glossiness of painted surfaces can be attributed, amongst which we would mention, for example, synthetic resins like phenolic, acrylic, alkyd, epoxy, styrene and polyurethane resins, etc., or cellulose derivatives (e.g. nitro-cellulose and acetyl cellulose) or natural resins (e.g. copal), and others which are normally known to experts in the sector;

b) filling substances, fillers or thickeners, such as, for example, calcium carbonate CaCO₃, which gives body to the paint or varnish;

c) a diluting agent such as, for example, a solvent or water;

d) one or more pigments, including TiO₂ titanium white and/or various types of colored pigments, natural or synthetic, organic or inorganic, having specifically a different covering power;

e) various additives, such as anti-mildew, anti-fermenting, quick-drying, anti-skinning compounds, etc.

According to the invention, one single monobasic product is prepared and this will contain predetermined proportions of binding element and filler, diluted in water or solvent depending on use and the characteristics of the finished varnish product. The additives, which generally have relatively low percentages in a paint, can either be already added to the monobasic product or added afterwards in the preparation of the finished paint.

In order to produce a finished paint in any color selected from the whole color range, amounts of filler and pigments are added to a predetermined amount of monobasic product, selected according to the end-use of the paint (and not on the basis of the color which the paint must have, as happens in the case of traditional tintometric systems); the percentages of said fillers and pigments are predetermined and the latter also contain TiO₂ titanium white, as well as the usual colored pigments, so that the total of the amounts of monobasic product, additional filler and pigments (as well as any additives, in the case where these are added to the monobase and are not already dispersed in the latter) give the total amount of paint required, in the desired color. The percentages of filler and pigments are defined by a formula predetermined by the manufacturer of the monobasic product and the colorings, who defines the optimum ratios of the different components in order to supply an optimized finished paint for each color in the color range.

### EXAMPLE 1

High quality paints have a high content of binding element and pigments, which are more costly than the filler, and which give the paint a good covering power and a good yield, thus making it more appropriate for professional use.

To obtain a high quality ivory colored paint, a high quality monobase must be selected, comprising about 35% of one or more binding substances and about 20% of a known filler with, possibly, about 14% additives. All said elements should be diluted in water or solvent, for example, depending on the type of binding or film-forming substances and, finally, the end-use for which the finished varnish product is intended.

To obtain a certain yield of final paint, corresponding to a value of 100% of a parameter which we will call “fill level”, we start from a preparation already containing about 72% fill level of the monobasic product described above. To achieve a fill level of 100%, the user or the dispensing machine will add about 28% of additional components to this monobasic product, schematically divided as follows: 25% TiO₂ in water or solvent and 3% yellow universal coloring. The paint that results from mixing the monobase with the additional components is ivory in color and is of high quality thanks to the high presence of about a total 25% binding substance.

### EXAMPLE 2

To obtain a high quality grey-colored paint, we start from the identical monobasic product as in Example I.

To achieve a fill level of 100%, we start from a preparation already containing about 72% of the monobasic product described above. The user or the dispensing machine must add about 28% of additional components to this monobasic product, schematically divided as follows: 10% TiO₂ in water or solvent and 3% black universal coloring, having a well-known covering power superior to that of yellow universal coloring, as well as 15% filler.

### EXAMPLE 3

To obtain a high quality black paint, we start from the identical monobasic product as in Example I.

To achieve a fill level of 100%, we start from a preparation already containing about 72% of the monobasic product described above. The user or the dispensing machine must add about 28% of additional components to this monobasic product, schematically divided as follows: 10% of black universal coloring, as well as 18% filler.

### EXAMPLE 4

Unlike high quality paints, low quality paints have a higher amount of filler—less expensive than binding element and pigments—and they are therefore more suitable for use by amateurs.

To obtain a low quality ivory-colored paint, we start from a monobase containing about 11% of one or more known binding elements and about 44% of a known filler, possibly in addition to about 11% additives. All said elements are diluted in water or solvent according to the characteristics of the binding element (film-forming substance) and, finally, of the use for which the finished painting product that we aim to obtain is intended.

To achieve a fill level of 100%, we start from a preparation already containing about 90% of the monobasic product described above. To this monobase, the user or the dispensing machine must add 10% of additional components, schematically divided as follows: 9.5% Ti0₂ in water or solvent and 0.5% yellow universal coloring. The resulting paint, after mixing the monobase with the additional components is a low quality paint, because of the strong presence of filler—about 40% of the total paint—in relation to the binding element.

### EXAMPLE 5

To obtain a low quality grey-colored paint we start from a monobase identical to the one shown in Example 4.

To achieve a fill level of 100%, we start from a preparation already containing about 90% of the monobase described above. To this monobase, the user or the dispensing machine must add about 10% of additional components, schematically divided as follows: 3% Ti0₂ in water or solvent and 0.5% universal black coloring and also 6.5% filler. The resulting paint, after mixing the monobase with the additional components, is a low quality paint, because of the strong presence of filler, which is over 45%.

### EXAMPLE 6

To obtain a low quality black paint we start from a monobase identical to the one shown in Example 4.

To achieve a fill level of 100% we start from a preparation already containing about 90% of the monobase described above. To this monobase, the user or the dispensing machine must add about 10% of additional components schematically divided as follows: 3% universal black coloring and also 7% filler. The resulting paint, after mixing the monobase with the additional components, is a low quality paint because of the strong presence of filler, equal to about 47% of the total paint.

The different percentages shown in the preceding examples are given mainly to allow comparisons to be made and must not therefore be considered as limiting and, consequently, they must not reduce the possibilities of making this invention, or the embodiments of it, which may be put into concrete form by an expert technician in the sector who is prepared to learn the instructions contained in this description. The percentages in the preceding examples are summarized in Table I below for the sole purposes of comparison.

TABLE I

| Monobase Type | | Content in | Content in | Filler |
|---|---|---|---|---|
| (composition) | Paint Type | Monobase | Pigments | Added |
| High Quality: | H.Q. Ivory | 72% High | 25% TiO₂ | 0% |
| approx. 35% | | Quality | 3% yellow col. | |
| binding elem., | H.Q. Grey | Monobase | 10% TiO₂ | 15% |
| 20% filler, | | | 3% black col. | |
| 14% additives and | H.Q. Black | | 0% TiO₂ | 18% |
| solvent or H₂O | | | 10% black col. | |
| as necessary | | | | |
| Low Quality: | L.Q. Ivory | 90% Low | 9.5% TiO₂ | 0% |
| Approx. 11% | | Quality | 0.5% yellow | |
| binding elem., | | Monobase | col. | |
| 44% filler, | L.Q. Grey | | 3% TiO₂ | 6.5% |
| 11% additives and | | | 0.5% black col. | |
| solvent or H₂O | L.Q. Black | | 0% TiO₂ | 7% |
| as necessary | | | 3% black col. | |

The difference between the two low and high quality types of paint, is given as an example to show how the only choices which necessarily have to be made by a user in making a finished paint are the selection of the desired coloration and the monobasic product in the most suitable quality according to the use for which the final paint product is intended (professional or amateur use). The percentages shown are, of course, by way of indication only and serve to illustrate by examples the innovative concept on which this invention is based, since the exact formulations can be obtained through experimentation by producers of paint products on the basis of the chemical-physical properties of the components and specific substances comprising the binding elements, fillers, colorings, etc.

It is important to notice how the results, which can be obtained with this invention, cannot be achieved simply by adopting the normal transparent or neutral basic product of traditional tintometric systems instead of the monobasic product in this invention. Said known basic transparent products, in fact, have a fairly high filler content and are suitable for making dark paints by adding low amounts of dark colorings which, as is well known, have a high covering power. If, with a traditional transparent base, we have to make a pastel colored paint with a satisfactory covering power, it would be necessary to add to it such high amounts of pigment that they would change the structure of the paint itself and would anyway be such as to lead to a rise in the cost of the paint to unacceptable levels.

The use for which the varnish or paint product is intended in relation to this invention defines the type of monobasic product adopted for the whole color range of the finished varnish product. Although there is a distinction made in the preceding examples between a high quality monobasic product and a low quality monobasic product, it is, of course, possible to have a different tintometric system, intended for the production of medium quality paints in comparison to those mentioned above. The components for producing paints which, in addition to the monobase, complete the tintometric system in this invention (pigments, titanium white, fillers and any additives) are supplied in a liquid form that is easy to transport in containers for liquids and simple to handle in the production of paint by means of, for example, the use of a generally known type of liquid dispensing machines.

### EXAMPLE 7

In order to obtain a medium quality white water varnish product, which is satisfactory, for example, for a semi-professional type of use, it is necessary to prepare a liquid monobasic product and a Ti0₂ solution.

The monobasic liquid is composed of about 24% binding emulsion, about 36% filler, about 6% cellulose paste and about 12% additives. All said elements are diluted in water, which reaches about 22% of the total volume of the monobase. The monobase therefore comes in liquid form, packaged in cans, and is easily transportable in containers of different formats.

The Ti0₂ titanium white solution is composed of about 75% in volume of TiO₂, about 1% bactericide, and about 2% dispersing or wetting agent. All said elements are diluted in water, which therefore reaches about 22% of the total volume of the TiO₂ solution.

Given the liquid components (liquid monobase and Ti0₂ solution) specified above, a white varnish product or white finished paint can be obtained by adding and mixing with an amount of liquid monobasic product, equal to 80% of the fill level, the remaining 20% of liquid solution of TiO₂ necessary to reach the fill level of 100%. The percentage in volume of each element in the finished paint product will therefore be about 20% (19.2%) binding emulsion, about 30% (28.8%) filler, about 15% TiO₂, about 5% (4.8%) cellulose paste, and about 10% (10.2%) additives. All said elements are diluted in water equal to about 22% of the total volume of finished product, since both the monobase and the titanium white are already supplied with a watery solution.

The percentages of the different elements present in the liquid components that comprise the finished paint are summarized in Table 2 below:

TABLE 2

| | Liquid | | White Paint |
|---|---|---|---|
| | Monobasic | | 80% Monobase |
| Element | Component | TiO₂ Component | 20% TiO₂ Solution |
| Emulsion | 24% | 0% | 19.2% |
| Water | 22% | 22% | 22.0% |
| Filler | 36% | 0% | 28.8% |
| TiO₂ | 0% | 75% | 15% |
| Cellulose Paste | 5% | 0% | 4.8% |
| Additives | 12% | 3% (=2% + 1%) | 10.2% |

### EXAMPLE 8

If, again using the liquid monobase in the preceding example, we want to obtain paints in different shades of grey until we arrive at the color black, it is sufficient to prepare a liquid filler component and a black universal coloring component, in addition to the liquid components shown above (liquid monobase and Ti0₂ solution).

The liquid filler component, for example, is composed of about 68% in volume of a mixture of products, filler dusts for example, of known type (the real “filler” element), about 2% cellulose paste, 3% binding emulsion, about 1% bactericide, about 1% dispersing or wetting agent. All said elements are diluted in the water, which therefore reaches about 25% in volume of the total of the liquid filler component.

The black universal coloring is of a type generally known in the sector and is already supplied in liquid form; it can therefore be easily mixed with the other components in the paint. The exact composition of the coloring does not influence this invention which only proposes to optimize, by reducing it to the minimum, the amount of coloring necessary to obtain the finished colored product desired.

Given the four liquid components mentioned above (canned liquid monobase, liquid filler, TiO₂ and black coloring which can be distributed), it is possible to obtain, for example:
a light grey paint by mixing about 18% of Ti0₂ solution and about 2% of black coloring with a monobase in a can filled to about 80% of the fill level, in order to obtain thus the fill level of 100%;
a medium grey paint by mixing about 10% of TiO₂ solution, about 4% of black coloring and also adding about 6% of liquid filler product, with a monobase in a can filled to about 80% of the fill level, in order to reach the total fill level of 100%;
a dark grey paint by mixing about 4% of Ti0₂ solution, about 6% of black coloring and then adding about 10% of liquid filler product, with a monobase in a can filled to about 80% of the fill level, in order to reach the total fill level of 100%;
a black paint by mixing about 8% of black coloring and about 12% of liquid filler product, with a monobase in a can filled to about 80% of the fill level, with no need to add the Ti0₂ solution.

The liquid monobase component is prepared in cans and containers that are already ready to receive the other components, given the substantial consistency in the percentage of liquid monobase component necessary to obtain paints in any color in the color range. Referring to the last examples 7 and 8, it is therefore possible to prepare, in the warehouse, containers of the required sizes, which are already filled to 80% of their volume with the single liquid monobase component used for the preparation of the final paints.

With the system of this invention it is therefore possible to reduce the number of components to be assembled when a paint in the desired color from the whole color range is being produced. The fundamental principle is that of formulating the base, as it is traditionally understood, from a single monobase for each quality of paint, by adding TiO₂ and/or filler—in predetermined amounts of above or equal to 0% according to the final color desired—when the color itself is prepared. This addition of possible amounts of titanium white and of filler component may of course be done either by hand or automatically with the aid of a dispensing machine, as already happens in the traditional tintometric systems, referring to the distribution of colored pigments in the known bases. With this invention, the use of coloring is optimized as it is never added in amounts that are larger than necessary since, unlike what happens in the traditional tintometric systems, it is never necessary to counterbalance an excess or a lack of titanium white. The resulting economy in the use of colorings is immediately translated into a lower cost for the finished paint, as well as in a lesser impact on the environment caused by the general noxiousness of the colorings themselves. To sum up, thanks to this invention, for each determined quality of finished paint, the covering power of the finished paint itself is also optimized.

It being understood that the principle of the invention naturally remains valid, its production characteristics and embodiments may vary in relation to the above description without thereby departing from the scope of the inventive concept.

What is claimed is:

1. In a method of making paints in which predetermined amounts of liquid products are mixed, the improvement comprising the steps of:
(a) preparing a primary liquid component which does not contain TiO₂ titanium white and comprises predetermined amounts of a binding element and a filler element; and
(b) adding predetermined amounts of at least one secondary liquid component selected from the group consisting of a liquid component containing TiO₂ titanium white and a liquid component comprising a filler to the primary liquid component, wherein the predetermined amount of the filler element in the primary liquid component is lower than the optimum amount and a black finished paint is obtained.

2. Method according to claim 1, characterized in that it also comprises the following step:
c) adding a predetermined amount of at least one liquid component comprising at least one pigment of coloring substance to the primary liquid component.

3. Method according to claim 1, characterized in that the predetermined amounts of binding element and of filling element included in the primary liquid component depend on the desired quality of the finished paint.

4. Method according to claim 1, characterized in that at least one additive selected from the group consisting of anti-mildew, anti-fermenting, quick drying and anti-skinning compounds is added to the primary liquid component.

5. Method according to claim 1, characterized in that the liquid components comprise predetermined amounts of a solvent.

6. Method according to claim 2, characterized in that steps b) and c) are carried out simultaneously.
